(19) United States
(12) Patent Application Publication
(10) Pub. No.: US 2025/0041888 A1
(43) Pub. Date: Feb. 6, 2025

(54) SINGLE-POLYMER DISPENSER FOR VISCOUS FLUIDS AND OILS

(71) Applicant: RIEKE PACKAGING SYSTEMS LIMITED, Leicester (GB)

(72) Inventors: Gaurang MITTAL, Uttar Pradesh (IN); Simon C. KNIGHT, Brigend (GB); Manuj SHARMA, Noida (IN)

(21) Appl. No.: 18/717,598

(22) PCT Filed: Dec. 13, 2022
(86) PCT No.: PCT/EP2022/085653

§ 371 Date: Jun. 7, 2024

(30) Foreign Application Priority Data
Dec. 13, 2021 (IN) 202141058034

(51) Int. Cl. B05B 11/10

(52) U.S. Cl. CPC B05B 11/1001; B05B 11/105; B05B 11/1059; B05B 11/1067; B05B 11/1077

(57) ABSTRACT

A reciprocating pump particularly well suited to dispensing oils, creams, and other viscous fluids is contemplated. All components of the pump are fabricated from a single polymer, such as polypropylene or high density polyethylene. The stem of the pump includes a three-piece sealing assembly with a piston that floats in response to the reciprocating action of the pump so as to selectively open or seal the dispensed fluid flow path, as well as return air provided to the internal volume of the container to which the pump is attached.

### CROSS REFERENCE TO RELATED APPLICATIONS

This application claims priority to Indian provisional patent application number 202141058034 filed on Dec. 13, 2021.

### TECHNICAL FIELD

This application relates generally to pump dispensers and, more specifically, to reciprocating pumps for dispensing fluids, preferably including oils, creams, and other viscous fluids, that are made entirely from a single grade of polymeric material and having an improved sealing assembly for selectively sealing the pump and container.

### BACKGROUND

Containers for everyday household fluid products, such as soaps, cleaners, oils, consumable liquids, and the like, can be outfitted with dispensing pumps to improve a consumer's ability to access and use the fluid. Dispensing pumps of this type usually rely upon a reciprocating pump, driven by a compressible, metallic biasing member.

These products tend to be single use, thereby giving rise to concerns about sustainability. Increasingly, regulatory authorities are requiring consumer products manufacturers to use product packaging and designs that can easily be recycled. As a practical matter for businesses relying on pump dispensers, it is becoming increasingly important to design products made only from polymeric materials. In this manner, such “all-polymer” pumps can be recycled without the need to disassemble and/or separate out metal parts and components made from difficult to recycle materials (e.g., metallic or foil parts, thermosetting resins, specialized elastomers, and other materials that either cannot be recovered or that require temperatures and conditions for recycling that are incompatible with the materials used in the other parts within the design).

When it comes to creating an all polymer or—more preferably—a single polymer reciprocating pump design, two of the more problematic components are anti-drip nozzles and biasing members. The former are sometimes made from elastomers but, because this is an optional feature, designs can simply eliminate that function or rely on solutions such as those proposed in U.S. Pat. Nos. 8,960,507; 10,252,841; 10,350,620; 10,717,565; and 10,723,528 (all of which are incorporated by reference).

With respect to biasing members, metallic springs provide a reliable and cost effective means of creating sufficient force to operate a reciprocating pump. However, examples of all-plastic biasing members can be found in Patent Cooperation Treaty Publication WO 1994/020221A1 and U.S. Pat. Nos. 5,819,990 and 5,924,603 (the latter being incorporated by reference). U.S. Pat. No. 10,549,299 and United States Patent Publication 2018/0318861, along with Patent Cooperation Treaty Application Nos. PCT/EP2020/070871 and PCT/EP2020/070878, also disclose alternative designs and components of/for dispenser pumps that can be constructed completely from polymeric and recyclable materials. All of these disclosures are all incorporated by reference as if fully reproduced herein and, thereby, inform and supplement this disclosure with respect to materials selection, construction, processes, and various other aspects of this disclosure and any claims based thereon.

While the aforementioned all-polymer dispensers work reasonably well in dispensing aqueous solutions and other low viscosity, easily-flowing liquids, liquids that leave a residue (like oils) and/or that are more resistant to flow (owing to their higher viscosity) may not work as well in these designs. As used herein, fluids with a measured viscosity (in cPs) that is at least one order of magnitude greater than water (with a viscosity of 1.00 cPs) is deemed viscous, and some highly viscous oils may at least two or three orders of magnitude greater. Also, high viscosity fluids are still in liquid form and, therefore, remain distinct from pastes, semi-solid materials, or slurries having a significant volume of solid particulates dispersed therein.

In the context of reciprocating pumps, viscous fluids are challenging because they tend to adhere to the sides of the pump chamber. This residue may potentially impeding the operation of the piston as it moves through the fluid/pumping chamber. The residue also requires reliable mechanisms to seal the pump when not in use, so as to avoid leakage during shipment or handling.

In view of the foregoing, an all-polymer pump dispenser made specifically for dispensing viscous liquids, including oils and highly viscous creams, would be welcome. Further, a pump design that did not require disassembly and separation of parts into separate recycling streams is needed. Finally, a all-polymer pump with sufficient ability to remain locked and sealed when not in use, while still delivering the ability to dispense fluids (and especially viscous fluids) is desirable.

### DESCRIPTION OF THE DRAWINGS

The appended drawings form part of this specification, and any information on/in the drawings is both literally encompassed (i.e., the actual stated values) and relatively encompassed (e.g., ratios for respective dimensions of parts). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure.

In the drawings and attachments, all of which are incorporated as part of this disclosure:

FIG. 1 is a cross sectional side view of one aspect of the inventive pump.

FIGS. 2A through 2H are three dimensional perspective views of isolated components of the pump shown in FIG. 1. In particular, FIG. 2A is the actuator head, FIG. 2B is the biasing member, FIG. 2C is the “push” stem, 2D is a combined view of the piston/wiper element and the substem around which it is fitted, FIG. 2E is the closure cap, FIG. 2F is the pump body/cylinder, FIG. 2G is the disk valve, and FIG. 2H is the dip tube.

FIGS. 3A and 3B are cross sectional side views the sealing assembly, which includes the push stem, substem, and piston/wiper element, illustrating the positioning of its components at differing points in time. FIG. 3A shows the pump on its down stroke in the open/operable position, with the arrows F indicating how fluid flows through the valve (on upstroke) and into the push stem (on the down stroke). FIG. 3B shows the pump in the extended position so that it is completely sealed and, in some instances, locked. Note that FIG. 3B is rotated ninety degrees in comparison to FIG. 3A to show the position of the vent aperture, and it also illustrates a ball valve, which is an alternative to the disk valve, sealing the inlet to the pump body and pump chamber defined by it.

FIG. 4 is a cross sectional side view of the sealing assembly illustrating how the piston/wiper seals to the substem via a pair of beads. A portion of the pump body is also shown for context.

FIG. 5 is a three dimensional, exploded, perspective view of the sealing assembly, but with only the bottom portion of the push stem shown.

FIGS. 6A and 6B are cross sectional side views illustrating an alternative arrangement for the sliding seal between the piston/wiper element and the substem, with FIG. 6A in the open position and FIG. 6B in the closed position. FIGS. 6C, 6D, and 6E are isolated cross sectional views of the lower portion of the push stem, the piston/wiper element, and the substem (respectively speaking).

FIGS. 7A through 7C are cross sectional side views illustrating the vent blocking/sealing aspect of the sealing assembly according to two aspects, with FIG. 7A showing a vent aperture in the sidewall of the pump body in the sealed/locked position and FIG. 7B showing that vent aperture in the sidewall in the open/operable position for return air flow into the container. FIG. 7C shows an alternative in which the vent aperture is provided at top corner edge of the pump chamber (in the sealed/blocked position) so as to enhance the locking seal and reduce the possibility of viscous residue flowing back down the sidewall and potential impairing operation of the pump.

FIGS. 8A and 8C are three dimensional, sectional views and FIGS. 8B and 8D are sectional top plan views, all isolating the push stem and the closure cap to show the interface between these elements. FIGS. 8A and 8B are in the closed and locked position, whereas FIGS. 8C and 8D are in the open/operable position.

FIGS. 9A through 9D illustrate an alternative arrangement for the locking mechanism and interface between the push stem and the closure cap. FIGS. 9A and 9B are, respectively speaking, isolated, three dimensional perspective views of the push stem and the closure cap. FIG. 9C is sectional top plan views, isolated to show the push stem and the closure cap in the open/operable position, whereas FIG. 9D is a similar view but in the closed and locked position.

### DESCRIPTION OF INVENTION

Operation of the invention may be better understood by reference to the detailed description, drawings, claims, and abstract-all of which form part of this written disclosure. While specific aspects and embodiments are contemplated, it will be understood that persons of skill in this field will be able to adapt and/or substitute certain teachings without departing from the underlying invention. Consequently, this disclosure should not be read as unduly limiting the invention(s).

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Reciprocating pumps are well-known. U.S. Pat. Nos. 11,173,508 and 10,953,421 and United States Patent Publications 2021/0260609; 2020/0346235; 2020/0206763; and 2019/0118205 (all of which are incorporated by reference) disclose conventional reciprocating pumps with improvements to the venting and locking mechanisms. However, these disclosures all rely upon metallic, coiled spring biasing members, and they all fail to acknowledge the unique challenges posed by dispensing viscous and highly viscous fluids.

The inventors realized that dispensing of such viscous fluids required particular attention to both the sealing of the venting mechanisms in the locked position, as well as the reliable performance of moving parts (including valves and sliding interfaces, such as between the piston within the pump chamber). Further still, because the aim is to create a polymeric and, more preferably, single polymer pump, the selected plastic resin must possess a balance of strength and resilience. For example, the use of comparatively “soft” low density polyethylene (LDPE) as required by some of the aforementioned patents relying upon plug seal interfaces is not appropriate for high-wear parts that may be subjected to cyclic periods of stress and relief (e.g., as might be the case where interfacing parts must seal an aperture when locked but also slide over one another when operable).

Also, previous attempts to adapt known all-polymer dispenser designs (such as those noted above) do not account for the unique challenges of pumps designs for oils and other thick or viscous liquids (generally referred to as “treatment pumps”). That is, treatment pumps must possess a robust construction in which the biasing member produces sufficient force to drive components forming a sealing interface past one another, even in the presence of residual oils/creams.

Thus, the inventors now propose a combination of specific features that enable an all-polymer pump, preferably made from the same resin (polypropylene or high density polyethylene), that can operate and seal as needed even when dispensing viscous fluids. In particular, the inventors rely upon a sealing assembly in which the piston/wiper element is permitted to “float” between upper and lower positions as it slide through the pump chamber. This arrangement is enabled through the use of a “substem” that is attached to the bottom of the push stem emanating from the actuator head itself.

Additionally, the piston/wiper element is provided with a series of parallel annular beads where it makes sliding contact with the substem. The spacing and size of these beads seals that interface and prevents viscous fluids from making unwanted ingress through the sealed surface, while an annular channel can be provided as a pocket between the stem and substem to further enhance contact of the beads and prevent unwanted displacement of the piston from its defined range of motion (i.e., the “float” as referenced above). Similarly, the selected diameter and size of the wiper wings on the piston (which seal and come into contact with the inner facing of the pump chamber/pump body cylinder) and a radial inner facing flange on the piston that rests on the substem as these parts rest and/or travel upward (and remain sealed/locked owing to the force of gravity) prevent leakage or unwanted fluid ingress at other positions. An upward protrusion or ridge on the lower extremities of the substem further enhance this seal.

The positioning of the make up/return air vent aperture was also significant. In one aspect, this aperture is positioned on the pump body at an elevation that corresponds to a midpoint between the wiper elements when the pump is in its locked state. This ensures that fluid from the container cannot escape through the vent aperture. In a further arrangement, this vent aperture is provided at the angled portion where the sidewalls of the pump body (which define the pump chamber) connect to a radial flange on the pump body that connects the body to the closure. By positioning the vent in this “corner,” it becomes possible to wedge the upper, outer wiper of the piston into a secure and sealed position in/over the vent.

Finally, more robust axial locking is provided between the push stem and a radial flange or shelf that is inherently (and necessarily) formed as part of the closure cap. In particular, reinforced axial ribs are disposed on the push stem at a position above the closure/flange so as to lock and prevent downward movement of the stem. Upon rotation of the actuator head (and push stem) relative to the closure, the ribs can be aligned with a slot formed in the closure cap's flange to allow downward axial travel, while additional interference features can be provided along rotationally interfacing parts to impede unwanted rotation. Optionally, the closure flange/deck can be imparted with a camming ramp/incline (tracing the rotational path of the ribs, so as to enhance the sealing force) and/or similar interference features to restrain the ribs in the locked position (protrusions, cooperating bead and groove.

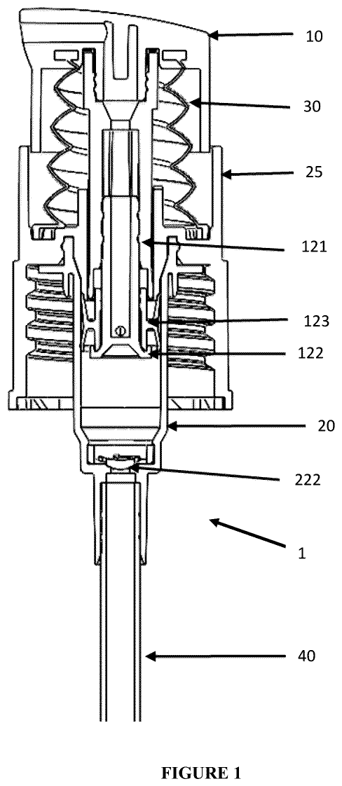

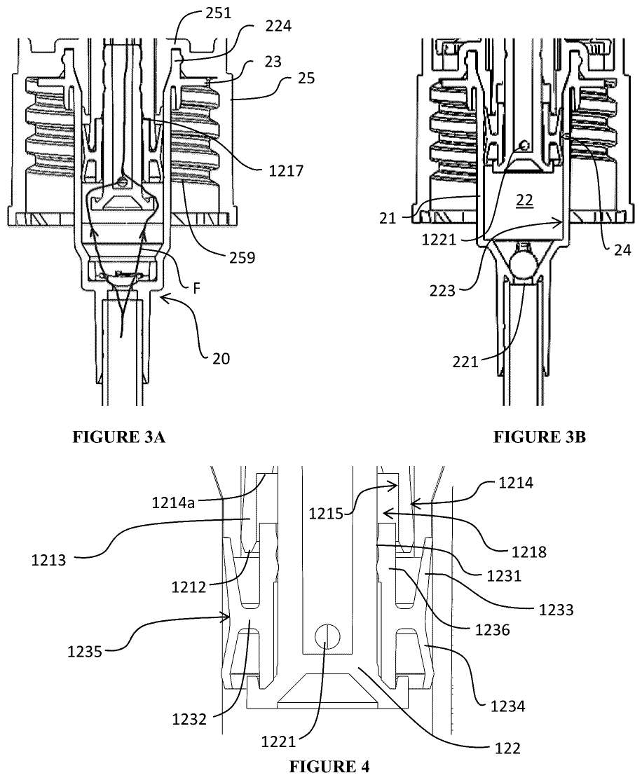

Turning now to FIGS. 1 through 8D, dispensing pump 1 generally includes an actuator 10, a pump body 20, a biasing member 30, and a dip tube 40. The actuator 10 includes an inlet 11, in fluid communication with the pump body 20, and a sealing assembly 12. The pump body 20 includes a pump chamber 22 and a closure cap 25.

The sliding seal assembly 12 has at least three discrete components—push stem 121 substem 122, and piston 123—so as to simplify assembly of the pump, allow for the use of comparatively harder/more rigid plastics (e.g., high density polyethylene in place of low density polyethylene), and generally provide for improved operation of the venting, sealing, and dispensing operations delivered by pump 1.

Actuator 10 defines a fluid flow channel that dispenses fluid from a container via outlet/nozzle 11. A flattened head and skirt 13 can impart an aesthetic, in addition to providing the user with an easy means/surface to press on for purposes of actuating the pump. Actuator 10 may be attached to pump 1 so that it rotates around an axis A-A relative to the closure 25, which is/will remain affixed to a container (not shown).

At an opposite end of the fluid flow channel, optional and detachable dip tube 40 connects to the lower inlet 221 of the pump body 20. Dip tube 40, like all components in the pump 1 positioned within the flow channel, includes and defines a sealed, hollow space capable of accommodating fluid flow. The outer diameter of the dip tube 40 cooperates with an inner diameter of an arcuate or circumferential flange around the inlet 221 to create a detachable interference fit.

A biasing member 30 is disposed between the actuator 10 and the closure 25. Notably, actuator 10 is configured to reciprocate in an up-and-down motion along axis A-A. Biasing member 30 creates force to separate these components but yield when sufficient actuation force is exerted along the reciprocating axis A-A.

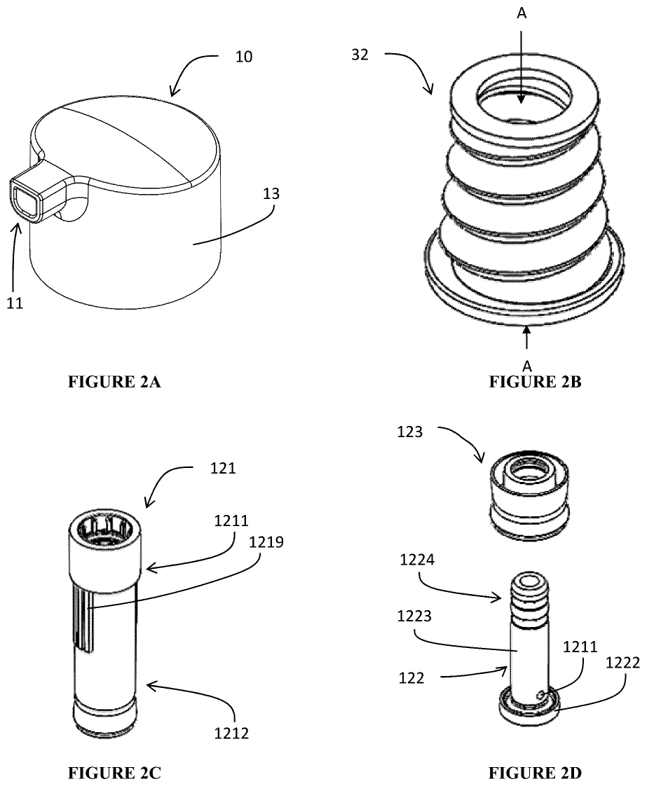

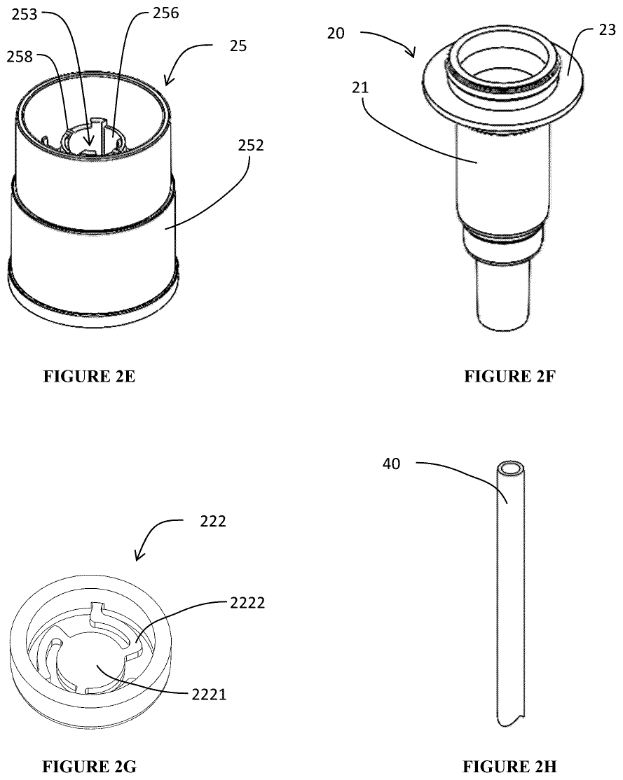

A preferred aspect of biasing member 30 is illustrated in FIGS. 1 and 2B. A plastic “bellows-style” member 32 is made from the same type of polymer as the other components (e.g., polypropylene or polyethylene) and includes accordion segments that resiliently compress and expand. Preferably, the accordion spirals around the cylindrical, cone-shaped body. Further details can be found in Patent Cooperation Treaty Publication WO 1994/020221A1, as well as U.S. Pat. No. 5,819,990, which are incorporated by reference. Still other configurations may be known, and all such configurations are contemplated to the extent they can be manufactured from the same polymeric material as the other components, as well as meet the other physical requirements contemplated herein (e.g., sufficient strength, chemical resistance, etc.).

Closure cap 25 is fixed to the container (not shown) by way of a conventional threaded connection. As such, closure 25 has a cup-like shape, with annular skirt 252 extending vertically downward from a flange 251 that extends radially inward at or near the top edge of the skirt 252. A cylindrical extension 256 may continue above the flange 251 to conceal the biasing member 30 and/or portions of the actuator 10. Threads or other coupling features 259 are disposed on a vertical facing of the skirt 252, preferably along its inner circumference. Radial flange 251 also defines a central aperture 253, through which the pump body 20 (and its various components) are coaxially received.

Interference features 258, such as protrusions, camming features, or ramps, are provided on an interfacing portion of the flange 251 and the push stem 121. Slots or cutouts 255 are formed along the periphery of the aperture 253. Features 255 and slots 258 are configured to cooperate with one or more axial or stopper ribs 1217 on the push stem 121 to provide secure up-locking and/or to prevent unwanted or accidental rotation of the actuator 10 (and the sealing assembly 12 coupled thereto) relative to the closure 25.

Additional features may be formed on the flange 251 or skirt 252 to facilitate connection of the biasing member 30 or to allow for air flows, particularly with respect to make up air required to unwanted avoid pressure differentials between the internal volume of the container (which is sealed by the closure 25) and the ambient environment surrounding the pump 1.

Pump chamber 22 is also coupled to or integrally formed with the closure 25, preferably along the flange 251. In some aspects, ridges or sloping features may be formed on or within the flange 251 so as to receive, couple to, and cooperate with extensions or features 224 on the top of pump chamber 25 to secure and seal these components. Chamber 22 has is hollow and has a cylindrical shape defined by elongated sidewalls 21. The sealing assembly 12 is received within the chamber 22 and moves axially therein. One or more vent apertures 24 are formed in the sidewalls 21 or proximate to their junction with a radial flange 23.

Flange 23 extends radially away from the sidewalls 21. Flange 23 conforms to at least portions of the cap 25, possibly along radial flange 252, so as to seal and secure all of the components of body 20 as a unitary member. The interface between the flanges 23, 252 may provide a path for return air. In some aspects, flange 23 may be seated on the top facing of flange 252, so that the coupling features with the biasing member 30 could be formed as part thereof. One or both of flanges 23, 252 may also possess interfacing cylindrical extensions positioned above the plane formed by flanges 23, 252 so as to provide for a locking mechanism 14 created by portions of the push stem 121 and the closure cap 25 (or the pump body 20 more generally). For the sake of simplicity, the remainder of this disclosure will refer to the locking mechanism 14 as being positioned on the closure 25 and, more particularly on its flange 252, but it will be understood that flange 23 could also conform or extend into and thereby define the central aperture 253 (in which case so as to allow the locking mechanism 14 to be provided as part of pump body 20 and, more particularly the flange 23). As will be described in greater detail below, locking mechanism 14 may take the form of ribs 1219 passing between slots 255, with a pocket 1218 and shelf 257 providing further aspects of mechanism 14, although it will be understood variations of this optional locking mechanism are possible.

While the sealing assembly 12 forms the upper reaches of pump chamber 22, the bottom portion of the body 20 includes an inlet 221 sealed by a valve 222. Inlet 221 can include one or more radial shoulders to define an aperture.

A valve 222 is seated on/in in the aperture of inlet 221 so as to seal the inner facings 223 of chamber 22. Suction/pressure differentials created by the reciprocating motion of the sealing assembly 12 within the chamber 22 provides temporary suction/pressure differential to pull the valve 222 upward and open the inlet 221 to admit fluid into the chamber 22. Valve 222 may be a conventional ball-style, possibly retained by fingers or projections confining the upper movement and displacement of the ball.

In another aspect, valve 222 has a disk shape. The disk can float freely, or it can include a central blocking portion 2221 and poppet-style connection legs 2222. Legs 2222 are connected to an outer periphery that can be fixed or formed as part of the sidewalls 21 and/or inlet 221.

Sealing assembly 12 is fixed to the actuator 10. As noted above, assembly 12 defines the fluid flow path that traverses thought the chamber 22 and out of the outlet 11. Further, assembly 12 moves in concert with the actuator 10, so that the biasing force created by member 30 must be sufficient to move all of these components. It will also be understood the reciprocating action of the actuator 10 and sealing assembly causes the volume of the chamber 22 to vary, thereby creating suction to drive fluid along the aforementioned flow path.

Assembly 12 includes push stem 121 which connects to the actuator 10. Push stem 121 has a bottom portion 120 and a top portion opposite thereof. Push stem 121 is a hollow tube that defines flow path.

Bottom portion 120 includes coupling features 1216 formed on the inner facing 1215 or outer facings 1214 of the stem 121. Features 1216 receive and attach to cooperating features 1224 on the substem 122. If the coupling features 1216 are provided on an outer facing 1214, these features can be formed along a thinned wall section 1213. The radially sloping shoulder 1214a that indicates the transition to the thinned section 1213 can also serve as an upper stopper 1217 for the axial movement of the piston 123, as will be described below. The thinned wall 1213 section may also flare radially outward, in some aspects beyond the outer diameter of the remainder of the push stem 121 so as to come into more intimate, sealing contact with the closure cap 25.

Substem portion 122 couples to the push stem 121 via features 1216, 1224. Substem 122 includes one or more inlets 1221. The hollow shape of substem 122 cooperates with the push stem 121 and imparts an L-shape (one inlet), T-shape (two inlets), or other similar shape for flow path.

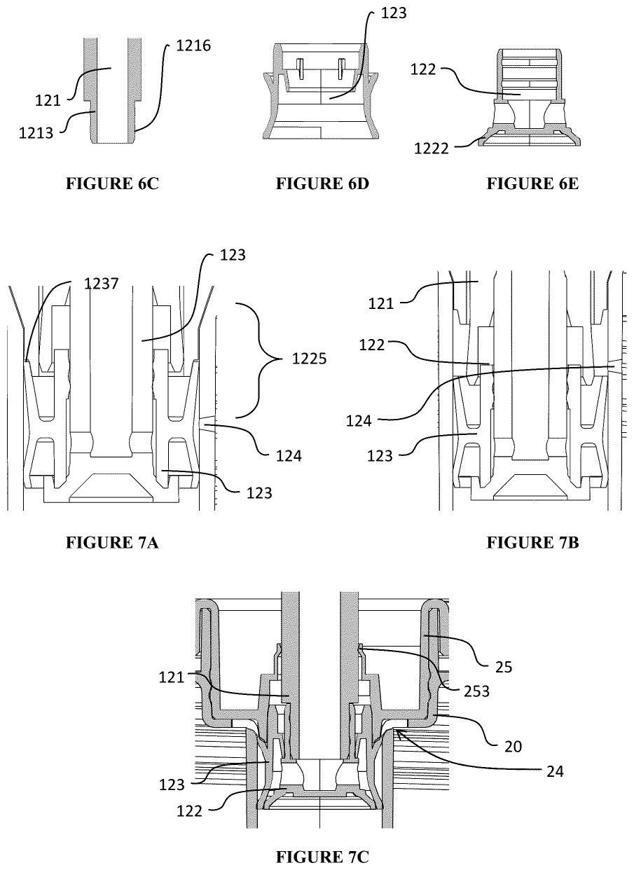

In some aspects, the thinned wall 1213 of push stem 121 can remain flush with the inner facing (as in FIGS. 6A and 6B) or outer facing (as in FIGS. 7A and 7B) of the push stem 121. When formed flush on the outer facing, the thinned wall 1213 and an outer facing of the substem 1214 (disposed between the coupling features 1216 and the inlet 1221 on the substem 122) define a pocket 1218.

Pocket 1218 includes an upper facing that may serve as the upper axial stopper 1217 for the piston 123. Additionally or alternatively, the axial facing (i.e., sidewall portions) of pocket 1218 may urge sealing features 1231 on the piston 123 into more intimate contact with the substem 122 to insure viscous fluids do not adhere and impair the performance of the sealing assembly 12. However, piston 123 should still slide freely along and within pocket 1218 (when present) and the substem 122 in general.

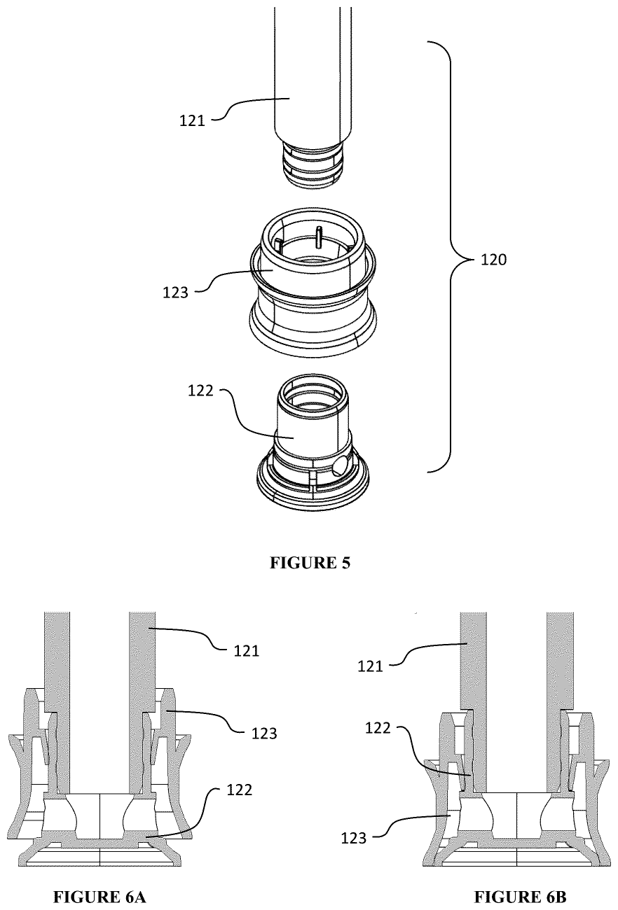

Substem 122 also includes a lower retention flange 1222. Flange 1222 may be provided as an annulus as seen in FIG. 5, although it could be formed along an arcuate section so long as the inlet 1221 is sealed (possibly by additional ribs on the substem 122 and/or piston 123) when the piston 123 is seated on, and sealing, the substem 122.

Sliding piston 123 is fitted over the substem 122 during assembly prior to attaching the substem 122 to the push stem 121. In this manner, the piston 123 can be manufactured from the same grade of polymer as the other assembly 12 components and without the need to force fit the piston 123 over the flange 1222. In turn, the assembly 12 is also made from the same polymer as the actuator 10, biasing member 30, pump body 20, and dip tube 40, thereby enabling a mono-polymer pump that can be recycled without the need to remove non-recyclable components (e.g., metal springs, elastomeric valves, glass ball valves, etc.).

Piston 123 has an annular configuration with stem-sealing features 1231 disposed on an upper cylinder 1236 that conforms to the substem 122. Separately, radial projections 1232 extend radially beyond the diameter of the cylinder defining the main portion of the piston 123. Upper projection 1233 conforms to and seals the inner facing of the sidewall 21, while lower projection 1234 is spaced axially apart but configured to do the same, with an indent region 1235 sized to cover and seal the vent aperture 24 when it is disposed in the sidewall 21. When the vent 24 is positioned at the junction of sidewall 21 and flange 23 (i.e., in an upper corner of the chamber 22), the upper edge of projection 1233 covers or even becomes partially wedged within the aperture 24. In either instance, the locking mechanism formed between the push stem 121 and flange 23 (and/or components coupled to it) insures that the seal is maintained and not inadvertently broken.

A stopper surface or shoulder 1237 is formed on one or both of the projections 1233 (or integrally on the main portion of the piston 123). This stopper 1237 cooperates with the cooperating upper stopper on the push stem 121 or substem 122 (e.g., top surface of pocket 1218, transition shoulder of thinned section 1213, etc.). This stopper 1237 insures the piston 123 is confined within an axial sliding seal range on the assembly 12. The lower retention flange 1222 defines the lower end of that sealing range.

Thus, when the assembly 12 reciprocates in concert with the actuator 10, the piston 123 temporarily slides upward to open the inlet 1221. Gravity normally urges the piston 123 downward to seal to the flange 1222 and block/seal the inlet 1221. As noted above, when the pump 1 is in the locked position, its inability to move downward insures that the piston 123 remains in place, covering the vent aperture 24. In this manner, the pump 1 is locked and effectively sealed, so as to allow for e-commerce shipping and handling of the pump 1 without concern that the inlet 24 could become unsealed so as to allow for leakage of fluid along flow path.

The locking mechanism 14 is premised on the interaction of stopper ribs 1219 with a corresponding stopper region on flange 23 (or elsewhere on body 20). As noted above, interference/camming features 1210, 258 (or elsewhere), require the ribs 1219 to “ride up” and over protrusions, cams, or ramps. Camming features can include a back stop protrusions, detents, and/or locating flanges to guide the ribs 1219 into a rest/locked position. To the extent the axial positioning of feature 1210, 258 coincides with the far-most range of biasing force exerted by member 30, the biasing member 30 also can help to seat and retain the ribs 1219 with the interference features 1210, 258. As previously noted, slots 255 allow for the ribs 1219 to pass freely when the actuator 10 and assembly 12 are rotated out of the locked position.

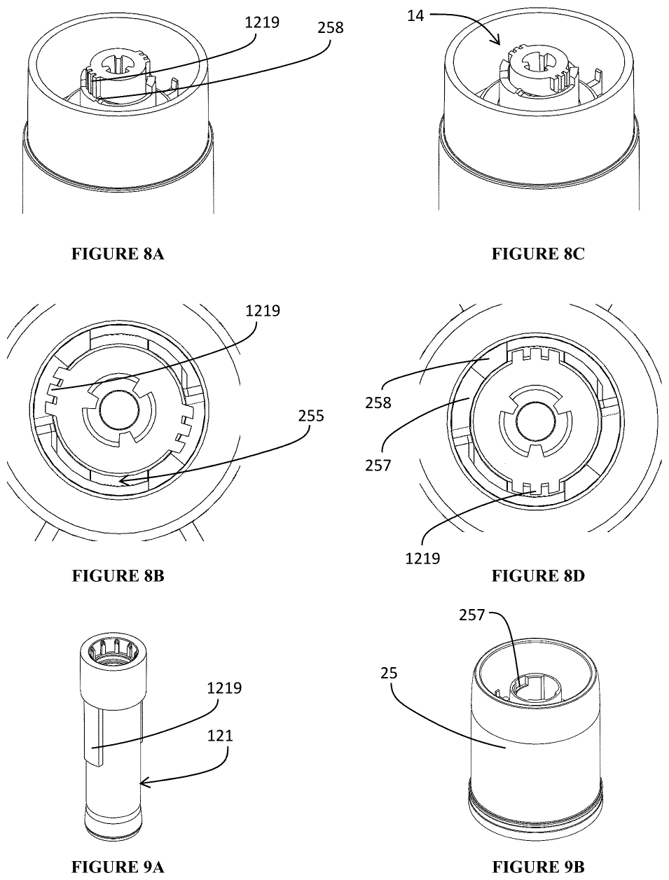

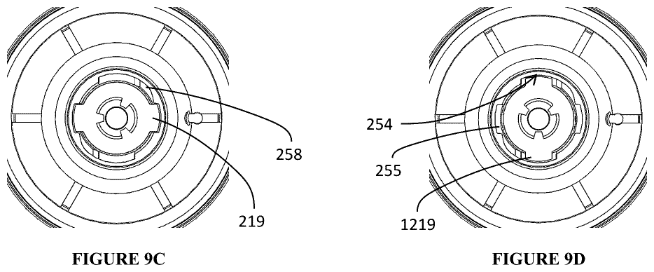

While the interface for the locking mechanism is depicted in FIGS. 8A through 8D as residing on an upper facing edge/end of the flange 23 (and, more specifically, a cylindrical extension formed thereon), FIGS. 9A through 9D illustrate an alternative in which camming/interference features are a shelf or similar formation is provided on an inner facing of that cylindrical extension (i.e., along a thinner arcuate section at the top edge/end). In this arrangement, the shelf may be immediately adjacent to the slots 255, which are also comparatively thinner arcuate sections on the inner surfaces defining the aperture 24. It is also possible to interpose a thicker, blocking section between the shelf and the slots 255, so that upper axial force must be applied to lift the stopper rib 1219 off of the shelf and before the actuator 10 can be rotated relative to the closure 25.

Notably, this locking mechanism allows the biasing member 30 to remain in a completely or largely non-tensioned state. This eliminates unnecessary stress and enables the use of polymeric materials, whereas many designs relying upon metallic components do not need to account for unnecessarily stressing the biasing member (owing to metal's superior strength and spring-action).

Another advantage to the aforementioned combination of sealing assembly 12 and closure 25 (and, more broadly, actuator 10 and pump body 20) is their ability to accommodate viscous and highly viscous fluids. Whereas previous pump designs—and particularly those relying on only one grade of polymer (including the biasing member)—encountered difficulty associated with the residue and slow flowing nature of these fluids, this combination allows for a good seal to be maintained without leakage issues experienced by conventional designs. The locking mechanism and sealing surfaces are believed to be particularly helpful in this regard.

In view of the foregoing, a first aspect of the inventive dispensing pump may include iterations of the following basic features: an actuator having a dispensing outlet in fluid communication with a sealing assembly; a pump body having cylindrical sidewalls defining a pump chamber sealed at a lower inlet by a valve and a flange extending radially outward from the cylindrical sidewalls and wherein the pump chamber is configured to coaxially receive a lower terminal end of the sealing assembly; closure cap coupled to the pump body and having a radial flange extending inward an annular skirt, said radial flange defining a central aperture configured to coaxially receive at least a portion of the cylindrical sidewalls defining the pump chamber; a biasing member urging the actuator away from the closure cap along an axis; and wherein the sealing assembly includes: (i) a push stem having a top portion coupled to the actuator and a bottom portion having coupling features and a stopper, (ii) a substem having a lower retention flange positioned beneath an inlet and cooperating coupling features disposed on a sidewall above the inlet, said cooperating coupling features attached to the coupling features on the push stem, and (iii) an annular-shaped piston coaxially receiving the substem and having sealing features interfacing with the sidewall of the substem and radially extending projections configured to seal to an inner facing of the pump chamber; and wherein the piston slides along the axis and between the stopper of the push stem and the lower retention flange of the substem so as to alternately open and seal the inlet.

Still further aspects may involve any combination or permutation of the following with the first aspect: wherein the pump body includes a vent aperture that is sealed by at least one of the radial projections on the annular piston when actuator is extended away from the closure cap; wherein the vent aperture is formed at a junction of the cylindrical sidewalls and the radial flange of the pump body; wherein the vent aperture is formed in the cylindrical sidewalls and positioned so as to be sealed between an upper radially extending projection and a lower radially extending projection on the piston; wherein the push stem includes at least one axial ribs and wherein the actuator is rotatable between a locked position in which axial movement of at least one of the axial ribs is arrested by the radial flange of the closure cap and an operable position in which a sufficient number of the axial ribs pass through slots formed along a periphery of the central aperture of the closure cap so as to allow actuation of the dispenser pump; wherein only one axial rib is provided on the push stem; wherein the interface between the at least one axial rib and the radial flange of the closure cap include interference features to impede rotation between the actuator and the closure cap; wherein the interface between the at least one axial rib and the radial flange of the closure cap include a camming ramp or incline formed along an arc of the central aperture; wherein the interface between the at least one axial rib and the radial flange of the closure cap occurs along a cylindrical extension protruding above the radial flange and wherein an inner facing of the cylindrical extension defines the slots; wherein the interface between the at least one axial rib and the radial flange of the closure cap occurs within a shelf formed on an inner facing of the cylindrical extension; wherein adjacent facings of the lower portion of the push stem and the substem define a pocket, said pocket having a top facing that is the stopper for the push stem; wherein the sealing features of the piston interface with the substem along a circumference of the substem and wherein the sealing features are urged into contact with the substem by an axial facing of the pocket; wherein the bottom portion of the push stem transitions to a thinned wall section at a lower terminal end of the push stem; wherein the substem is coupled to an outer facing of the thinned wall section, and the stopper is defined by a shoulder on the lower portion adjacent to the thinned wall section; and wherein the substem is coupled to an inner facing of the push stem at or above the transition to the thinned wall section. These combinations and permutations may be paired with any of the previously mentioned basic features.

Finally, all of the aforementioned aspects may be further combined with any combination or permutation of the following: wherein the biasing member is a bellows spring; wherein all components of the dispensing pump are constructed from a single grade of polymer; wherein the single grade of polymer is polypropylene or polyethylene; and wherein the polyethylene is high density polyethylene.

All components of the pump dispenser should be made of materials having sufficient flexibility and structural integrity, as well as a chemically inert nature. Certain grades of polypropylene and polyethylene are particularly advantageous, especially in view of the absence of any thermosetting resins and/or different, elastomeric polymer blends. Notably, high density polyethylene (i.e., having a density of greater than 0.940 g/cm³) possesses certain advantages over lower density polyethylene types (e.g., medium density at 0.925 to 0.940 g/cm³ and/or lower density at 0.880 to 0.925 g/cm³), as well as allowing for consideration of other specialized, stiffer versions having cross-linking. Copolymers may also be used, although grades that cannot be easily recycled are not favored.

The polymeric materials should also be selected for workability, cost, and weight. Common polymers amenable to injection molding, extrusion, or other common forming processes should have particular utility.

References to coupling in this disclosure are to be understood as encompassing any of the conventional means used in this field. This may take the form of snap- or force fitting of components, although threaded connections, bead-and-groove, and bayonet-style/slot-and-flange assemblies could be employed. Adhesive and fasteners could also be used, although such components must be judiciously selected so as to retain the recyclable nature of the assembly.

In the same manner, engagement may involve coupling or an abutting relationship. These terms, as well as any implicit or explicit reference to coupling, will should be considered in the context in which it is used, and any perceived ambiguity can potentially be resolved by referring to the drawings.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

What is claimed is:

1. A dispensing pump comprising:
an actuator having a dispensing outlet in fluid communication with a sealing assembly;
a pump body having cylindrical sidewalls defining a pump chamber sealed at a lower inlet by a valve and a flange extending radially outward from the cylindrical sidewalls and wherein the pump chamber is configured to coaxially receive a lower terminal end of the sealing assembly;
closure cap coupled to the pump body and having a radial flange extending inward from an annular skirt, said radial flange defining a central aperture configured to coaxially receive at least a portion of the cylindrical sidewalls defining the pump chamber;
a biasing member urging the actuator away from the closure cap along an axis; and
wherein the sealing assembly includes: (i) a push stem having a top portion coupled to the actuator and a bottom portion having coupling features and a stopper, (ii) a substem having a lower retention flange positioned beneath an inlet and cooperating coupling features disposed on a sidewall above the inlet, said cooperating coupling features attached to the coupling features on the push stem, and (iii) an annular-shaped piston coaxially receiving the substem and having sealing features interfacing with the sidewall of the substem and radially extending projections configured to seal to an inner facing of the pump chamber; and
wherein the piston slides along the axis and between the stopper of the push stem and the lower retention flange of the substem so as to alternately open and seal the inlet.

2. The dispensing pump of claim 1 wherein the pump body includes a vent aperture that is sealed by at least one of the radially extending projections on the annular piston when actuator is extended away from the closure cap.

3. The dispensing pump of claim 2 wherein the vent aperture is formed at a junction of the cylindrical sidewalls and the radial flange of the pump body.

4. The dispensing pump of claim 2 wherein the vent aperture is formed in the cylindrical sidewalls and positioned so as to be sealed between an upper radially extending projection and a lower radially extending projection on the piston.

5. The dispensing pump of claim 1 wherein the push stem includes at least one axial ribs and wherein the actuator is rotatable between a locked position in which axial movement of at least one of the axial ribs is arrested by the radial flange of the closure cap and an operable position in which a sufficient number of the axial ribs pass through slots formed along a periphery of the central aperture of the closure cap so as to allow actuation of the dispenser pump.

6. The dispensing pump of claim 5 wherein only one axial rib is provided on the push stem.

7. The dispensing pump of claim 5 wherein the interface between the at least one axial rib and the radial flange of the closure cap include interference features to impede rotation between the actuator and the closure cap.

8. The dispensing pump of claim 5 wherein the interface between the at least one axial rib and the radial flange of the closure cap include a camming ramp or incline formed along an arc of the central aperture.

9. The dispensing pump of claim 5 wherein the interface between the at least one axial rib and the radial flange of the closure cap occurs along a cylindrical extension protruding above the radial flange and wherein an inner facing of the cylindrical extension defines the slots.

10. The dispensing pump of claim 9 wherein the interface between the at least one axial rib and the radial flange of the closure cap occurs within a shelf formed on an inner facing of the cylindrical extension.

11. The dispensing pump of claim 1 wherein adjacent facings of the lower portion of the push stem and the substem define a pocket, said pocket having a top facing that is the stopper for the push stem.

12. The dispensing pump of claim 11 wherein the sealing features of the piston interface with the substem along a circumference of the substem and wherein the sealing features are urged into contact with the substem by an axial facing of the pocket.

13. The dispensing pump of claim 1 wherein the bottom portion of the push stem transitions to a thinned wall section at a lower terminal end of the push stem.

14. The dispensing pump of claim 13 wherein the substem is coupled to an outer facing of the thinned wall section, and the stopper is defined by a shoulder on the lower portion adjacent to the thinned wall section.

15. The dispensing pump of claim 14 herein the substem is coupled to an inner facing of the push stem at or above the transition to the thinned wall section.

16. The dispensing pump of claim 1 wherein the biasing member is a bellows spring.

17. The dispensing pump of claim 1 wherein all components of the dispensing pump are constructed from a single grade of polymer.

18. The dispensing pump of claim 17 wherein the single grade of polymer is polypropylene or polyethylene.

19. The dispensing pump of claim 18 wherein the polyethylene is high density polyethylene.
